(19) United States
(12) Patent Application Publication
(10) Pub. No.: US 2004/0186041 A1
(43) Pub. Date: Sep. 23, 2004

(54) Phyllosilicate-intercalation compounds with increased expansion volume, method for their synthesis and their use

(76) Inventors: Antje Wenzel, Hofstetten (DE); Arne Reinheimer, Zellerberg (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/737,276

(22) Filed: Dec. 16, 2003

(30) Foreign Application Priority Data
Dec. 17, 2002 (DE) 102 59 083.4

(51) Int. Cl. C11D 3/02

(52) U.S. Cl. 510/511

(57) ABSTRACT

A method is described for producing phyllosilicate-intercalation compounds with an increased expansion rate and/or a modified onset temperature by intercalating intercalate compounds in native, expandable phyllosilicates, especially native vermiculite. The method is wherein at least one representative of the group comprising alcoholates of lithium and potassium and salts of lithium, sodium and potassium with organic acids is intercalated as intercalate compounds in the native phyllosilicate. Furthermore, the phyllosilicate-intercalation compounds obtained thereby and their use as intumescing materials, as intumescing, fire-retarding additive and/or in expanded form, can be used as additive for producing flame-retarding materials, as well as for preparing high temperature-resistant insulating panels and seals.

### FIELD OF INVENTION

The present invention relates to a method for producing phyllosilicate-intercalation compounds with an increased expansion volume and a modified onset temperature by intercalating intercalate compounds in native, expandable phyllosilicates, especially in native vermiculite, to the thereby obtained phyllosilicate intercalation compounds and to their use as intumescing material and/or, in expanded form, as additive for producing fire-retarding materials and high temperature-resistant insulating panels as well as seals.

### BACKGROUND INFORMATION AND PRIOR ART

Expandable phyllosilicates, such as vermiculite, are built up from octahedral and tetrahedral layers, between which exchangeable cations, such as magnesium and aluminum cations, are intercalated, the proportions of which vary depending on the origin of the phyllosilicate. Because of the presence of interlayer water, such expandable phyllosilicates are subject to expansion when heated because the interlayer water is released spontaneously at higher temperatures, so that the layers are forced apart. The temperature, at which the expansion process sets in, is referred to as the onset temperature, which is at 320° C., for example, in the case of native, expandable vermiculite, as used in the following comparison example.

Such expandable phyllosilicates, like expandable graphite, are used because of this thermal expansion behavior as intumescing fire-retarding additives for the production of fire-retarding compositions, for example, for the fire-retarding sealing of through holes, wall bushings and other openings in walls, floors and/or corners of buildings. In the event of a fire, the expandable phyllosilicate, present in the fire-retarding composition, expands so that, even after the matrix material of the flame-retarding composition has been burned away, the opening, which is to be sealed, remains closed for a further period of time due to the expansion of the phyllosilicate.

Depending on the nature of the pipe wall bushings, such fire-retarding bulkhead systems must satisfy different requirements. For example, in the case of the very rapidly melting and combusting polyurethane pipes, the resulting opening must be closed within a very short time. This requires the intumescing material to have a high expansion rate and a large expansion volume. Accordingly, as in the case of the onset temperature, a high measure of variability is required also with regard to these parameters also, for example, in order to be able to adjust the expansion behavior of the intumescing fire-retarding materials selectively to the special product requirement for the production of such fire-retarding materials. In contrast to expandable graphite, which has previously been used as the standard intumescing material, but is burned oxidatively at high temperatures, the expandable phyllosilicates, such as vermiculite, are distinguished by their high thermal stability. However, in native form, these expandable phyllosilicates have only a moderate pressure-increasing expansion behavior, which greatly limits the use of these materials in passive fire protection.

Due to the small number of commercially obtainable vermiculite types, the matching of the volume increase and the rate increase, as well as the necessary flexibility, required for matching the flame-retarding materials selectively to the intended use, can be attained only inadequately.

However, due to the limited selection of intercalate compounds (guest compounds), the variations of the expansion properties, particularly of the expansion volume and of the onset temperature, of the commercially obtainable phyllosilicates is limited. However, in order to be able to react flexibly to the special product requirements, especially in the area of passive fire protection, expandable phyllosilicate-intercalation compounds are required, which make possible a higher range of variation and a selective adjustment of their intumescing properties, especially with regard to the expansion volume and the onset, that is, the temperature at which expansion commences.

The modification of expandable phyllosilicates by intercalating guest molecules is already known and is usually carried out by dispersing the silicate particles in a solution of the corresponding guest compound. Inorganic salts as well as organic compounds can be intercalated as guest molecules. The onset temperature of commercially available phyllosilicates is about 300° C.

For example, U.S. Pat. No. 4,305,992 describes an intumescing sheet material with a greatly reduced negative expansion behavior, which contains an expandable vermiculite with a particle size of about 0.1 mm to 6 mm, the onset temperature of which has been adjusted by cation exchange with ammonium phosphate, ammonium carbonate, ammonium acetate, ammonium hydroxide and urea to a temperature, significantly lower than that of conventional vermiculites.

The object of U.S. Pat. No. 5,116,537 and of the corresponding European patent application 0 429 246 is a vermiculite, which can be expanded at low temperatures, and intumescing sheet material, which contains this as an intumescing fire-retarding additive. In the specification, it is pointed out that the vermiculite, known from the above-mentioned U.S. Pat. No. 4,305,992, has expansion temperatures, which are still too high for many intended applications, so that the teachings of this state of the art are directed to lowering the expansion temperature of the vermiculite even further. This is achieved owing to the fact that a cation exchange is brought about with potassium ions, which are introduced by the use of a potassium nitrate solution. As stated there, even lower expansion temperatures can be achieved thereby than by ion exchange with ammonium nitrate, potassium chloride and ammonia chloride.

However, the expandable phyllosilicates, obtained by this state of the art, are not completely satisfactory, because selective matching of the properties of the intumescing fire-retarding additive to the receptive binder matrix of the fire-retarding material cannot be achieved. As already stated above, melting metal and plastic pipes must be squeezed off in the case of passive fire protection by the expanding process of the intumescing materials, in order to close off thereby the cavity, formed by the shrinking process of the pipe wall bushings, quickly once again with the formation of a mechanically stable and thermally insulating protective layer. For this purpose, intumescing materials with a pressure in creasing expansion are required, for which the expansion process does not terminate in spite of the resistance or counter pressure, as is it does, for example, in the case of the chemical intumescence, brought about by the reaction of carbon donors (such as starch and pentaerythritol), acid donors (such as ammonium polyphosphate) and blowing agents (such as melamine).

Moreover, the expansion process may set in only when the binder matrix of the fire-retarding composition has softened, since only then a synergistic effect and the best possible efficiency of the pressure-increasing expansion of the expandable phyllosilicate can be attained. It is therefore necessary to have expandable phyllosilicates available, the properties profile of which can be adjusted selectively and more accurately with respect to the expansion behavior. In this connection, it is particularly important to be able to modify the onset temperature in the desired manner at an elevated expansion rate.

Moreover, according to the teachings of the U.S. Pat. No. 5,116,537 and of the corresponding European patent application 0 429 246, expandable vermiculites, produced using potassium nitrate, are unsuitable for fire protection especially because of the corrosive behavior and the potential danger to health of the potassium nitrate remaining in the vermiculite. For producing suitable, passive fire-protection products, it is necessary to keep the consequential damage and the health risks as small as possible and to avoid poisonous, aggressive fire-promoting additives and auxiliary materials, in order to keep the fire load as small as possible. Since potassium nitrate, as intercalation compound, releases corrosive nitrous gases during the decomposition of the expandable phyllosilicate, vermiculites of this state of the art are disadvantageous especially when used for sealing cable wall bushings. Taking into consideration the fact that such a fire-protection products may contain up to 40% of the intumescing fire-retarding additive, that is, of the potassium nitrate-exchanged vermiculite, very high concentrations of gases, released during the decomposition, arise in the event of a fire. This is particularly serious in the event that it is necessary to seal large openings for cable bulkheads and/or cable shafts, containing many cables, such as those, which occur in the telecommunication area and in network leads, since, aside from large amounts of material present for the fire-retarding sealing, the rooms frequently are also small, so that an undesirable concentration of the poisonous gases in the smoke may result.

Finally, the potassium nitrate, which is contained in the phyllosilicates of the state-of-the-art, is unsuitable as a fire-retarding agent because of its properties, since it is a fire-promoting material, which sustains combustion because it gives off oxygen and, with that, actively promotes the degradation of the polymer matrix of the intumescing fire-retarding products. Since fire-retarding systems should aim to avoid spreading the focus of the fire and to bring about self-extinction of the fire, it seems that the use of potassium nitrate by expandable phyllosilicates modified by cation exchange is in fact totally unsuitable as an intumescing fire-retarding additive in the area of five protection.

### OBJECT OF THE INVENTION

It is therefore an object of the invention to indicate a method for producing phyllosilicate-intercalation compounds, which are particularly suitable for passive fire protection and which, while having a pressure-increasing expansion behavior, can be adjusted selectively with respect to their higher expansion rate and their onset temperature.

### SUMMARY OF THE INVENTION

Surprisingly, it has turned out that, for the modification of the expansion behavior of expandable phyllosilicates by cation exchange, the expansion properties of the phyllosilicates obtained can be adjusted positively not only by the selection of the appropriate metal cations, but also by the selection of the anions used, since obviously the anions are also co-intercalated partly and, by their decomposition, render a contribution to the expansion process.

The object, named above, is therefore accomplished by the method of the main claim. The dependent claims relate to preferred embodiments of this inventive object, as well as to the phyllosilicate-intercalation compounds, obtainable by this method, and to their use as intumescing materials, which can be used as intumescing fire-preventing additive and/or in expanded form as additive for the preparation of fire-retarding materials, as well as for the preparation of high temperature-resistant insulation panels and seals.

The object of the invention therefore is a method for the preparation of phyllosilicate-intercalation compounds of increased expansion rate and/or modified onset temperature by intercalating intercalate compounds in native, expandable phyllosilicates, especially native vermiculite, which is wherein, as intercalate compound, at least one representative of the group comprising alcoholates of lithium and potassium and salts of lithium, sodium and potassium is intercalated in the native phyllosilicate by cation exchange.

Surprisingly, it has turned out that, with the above-describe procedure and the thereby used intercalate compounds, a high variability of the properties of the phyllosilicate-intercalation compounds, obtainable pursuant to the invention, can be obtained, particularly with regard to the expansion rate, the onset temperature and the expansion volume.

The onset temperature (° C.), addressed here, is defined as the temperature, at which the thermal expansion process of the intumescing system, that is, of the inventive phyllosilicate-intercalation compounds here, commences. In other words, this is the temperature at the start of the expansion process. The conventional, commercially obtainable, expandable native phyllosilicates, for example, the native vermiculite from China, addressed in Example 1, have an onset temperature of 320° C., if this temperature is determined with the help of the method described below and the measurement conditions given.

The expansion rate (%/° C.) is defined as the percentage increase in the volume of the phyllosilicate-intercalation compounds, determined in the following way, per ° C. of temperature increase.

The expansion volume (%/mg) is standardized to the amount of phyllosilicate-intercalation compound and corresponds to the difference between the initial volume and the final volume of the completely expanded phyllosilicate-intercalation compound. Further details concerning the determination of this parameter are given further on in the specification.

Preferably, a salt of an optionally substituted organic carboxylic acid with one or more carboxyl groups is used as intercalate compound for the inventive method. Particularly preferred are the salts of optionally substituted organic carboxylic acids of the general formula R(COOH)n, in which R represents an optionally substituted alkyl, cycloalkyl, alkenyl, cycloalkenyl, aryl, arylalkyl, arylcycloalkyl, alkylaryl or cycloalkylaryl group with 1 to 30 and preferably with 1 to 18 carbon atoms and n is a whole number with a value of 1 to 4 and preferably of 1 or 2. As substituents, the preferred organic carboxylic acids contain one or more representatives of the group comprising halogen atoms, ether, ester, amino, amide, hydroxy and urea groups.

In accordance with a particularly preferred embodiment of the invention, a salt of formic acid, acetic acid, propionic acid, butyric acid, oxalic acid, tartaric acid, hexanoic acid, adipic acid, malonic acid, glycolic acid citric acid, lactic acid, glyoxylic acid, trifluoroacetic acid salicylic acid, nitrilotriacetic acid and/or ethylenediaminetetraacetic acid (EDTA) is incorporated as intercalate compound in the native, expandable phyllosilicate.

In accordance with a further preferred embodiment, an alcoholate of lithium or potassium with a monovalent or multivalent aliphatic or aromatic alcohol, such as methanol, ethanol, 2-propanol, 2-butanol, t-butanol, benzyl alcohol, 1-decanol, ethylene glycol, 1,3-dihydroxypropane, 1-4-dihydroxybutane and/or glycerin is intercalated as intercalate compound.

Pursuant to the invention, the intercalation of lithium citrate, lithium formate, lithium acetate, sodium formate, sodium oxalate, sodium gluconate, sodium methylate, sodium ethylate, sodium propylate, potassium formate, potassium acetate, potassium gluconate, potassium oxalate and/or the dipotassium salt of ethylenediaminetetraacetic acid are particularly preferred.

As native, expandable phyllosilicate, preferably expandable vermiculite, hydrobiotite and/or chlorite vermiculite with an average particle diameter of 0.1 mm to 10 mm and preferably of 0.3 to 1.0 mm is used pursuant to the invention.

Preferably, the method is carried out by suspending the phyllosilicate in a solution of the intercalate compound in a suitable solvent, bringing about the intercalation optionally with heating and separating the phyllosilicate-intercalation compound obtained from the suspension and optionally washing and drying it.

As solvent, water, an aliphatic or aromatic alcohol, an ether, an ester, an alkane, a cycloalkane, an aromatic solvent and/or an amino can be used here. However, water is particularly preferred as solvent.

The method preferably is carried out at a concentration of the intercalate compound in the solution of 0.01 mole/L to 5.0 mole/L and preferably of 0.1 mole/L to 1.0 mole/L. Advantageously, the intercalation reaction is carried out at a temperature of 10° C. to 150° C. and preferably of 25° C. to 60° C. for a reaction time of 0.5 to 144 hours and preferably of 10 to 36 hours.

After the reaction, the phyllosilicate-intercalation compound is removed from suspension by filtering or decanting, washed optionally with a few milliliters of the solvent used and then dried. The drying can be carried out at room temperature, under vacuum or in a drying oven at room temperature, but also at an elevated temperature. Preferably, the drying is carried out in the drying oven for 1 to 12 hours at a temperature of 60° to 80° C.

A further object of the invention are the phyllosilicate-intercalation compounds, obtainable by the method described above, as well as their use as intumescing material, which can be used as such as intumescing fire-retarding additive and/or in expanded form as additive for the production of flame-retarding materials, as well as for the production of high temperature-resistant insulation panels and seals, especially for the fire-retarding sealing of through holes, wall bushings and other openings in walls, floors and/or ceilings of buildings. For this purpose, these phyllosilicate-intercalation compounds are brought into matrix material in a manner conventionally used for such applications, in amounts necessary for the intended expansion effect.

The above-addressed expansion properties of the phyllosilicate-intercalation compounds, obtainable pursuant to the invention, are measured by thermomechanical analysis of the dimensional changes of the material as a function of temperature. For this purpose, a sample is placed on a sample carrier, which is provided with a measuring probe and brought into an oven, which is heated over a pre-determined temperature range using a suitable temperature program. The measuring probe may in addition be acted upon by a variable load. A positive to dimensional change during this measurement is referred to as expansion.

In order to determine the expansion behavior of the phyllosilicate-intercalation compounds obtainable pursuant to the invention, the powdery sample is transferred to a corundum crucible and covered with a steel crucible. The steel crucible ensures smooth transfer of the dimensional change of the sample to the measuring probe during the expansion of the sample. This crucible arrangement is placed on the sample carrier of the thermomechanical apparatus (TMA) and introduced into the oven:

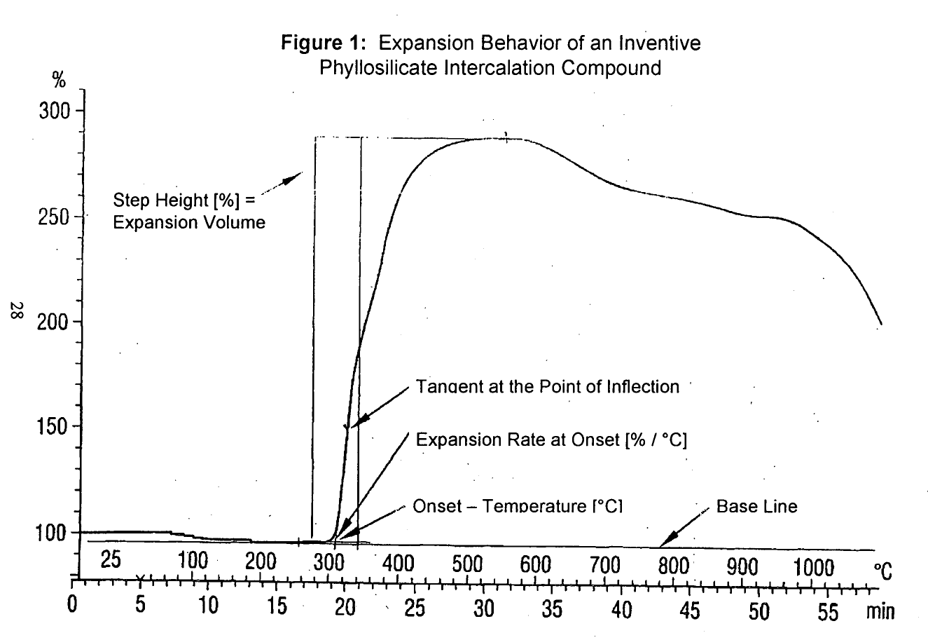

As a result of such a thermomechanical analysis, a curve, such as that shown in the attached drawing, is obtained, in which, in the single FIG. 1, the percentage expansion of the material is plotted as a linear displacement of the steel crucible as a function of the temperature.

The onset temperature (° C.) of the phyllosilicate-intercalation compound is defined mathematically as the intersection of the extended baseline before the expansion of the sample and the tangent at the point of inflection of the expansion curve.

The expansion rate of the intumescing material investigated in the area all the onset corresponds to the slope of this tangent at the point of inflection. The unit of expansion accordingly is %/° C.

The expansion volume corresponds to the horizontal step between the baseline and the maximum of the curve. It gives the expansion of the substance or the extension of the initial length in %. Since the volume depends on the sample weight for these measurements, the expansion volume is standardized to the sample weight. As a result, the unit is the standardized expansion volume in %/mg.

All measurements of the phyllosilicate-intercalation compounds prepared, given in the following examples, were made with samples of comparable particle size distribution ranging from 0.3 mm to 1.0 mm.

The following conditions were maintained for determining the parameters of the expansion behavior using this measuring equipment:

| | |
|---|---|
| Apparatus: | TMA/SDTA840 of Mettler/Toledo, Gieβen, DE |
| Temperature program: | dynamic mode (with prior isothermal phase for 5 |
| | minutes at 25° C.) |
| Heating rate: | 20° C./min |
| Temperature range: | 25° C. to 1100° C. |
| Analysis gas: | synthetic air |
| Flow rate: | 60 mL/min |
| Load: | 0.06 N |
| Sample vessel: | 150 μL corundum crucible + 150 μL steel crucible |
| | (as lid) |

When the phyllosilicate-intercalation compounds, obtainable pursuant to the invention, are used as intumescing fire-retarding additive, a lower or higher onset temperature is required depending on the application, whereas preferably an increased expansion volume is required at all times. These properties must be matched to the melting behavior of the cable and pipe wall bushings. Pursuant to the invention, it is readily possible to match the start of the expansion of the phyllosilicate-intercalation compound precisely to the area of use and, in this way, to achieve a higher variability of the intumescing materials for passive fire protection.

The phyllosilicate-intercalation compounds, obtainable pursuant to the invention, expand when heated to the onset temperature. This heating can be carried selectively in an oven for producing correspondingly expanded products or by other heat sources, if present, such as fire, light radiation or electric pulses. This is also so if the phyllosilicate-intercalation compounds are embedded in a binder matrix with formation of a fire-retarding sealing composition. In this connection, it should be noted that the phyllosilicate-intercalation compounds, produced pursuant to the invention, also expand under load and, with that, are capable of releasing very strong expansion forces. This is of importance particularly for their use as intumescing material.

The following Examples are intended to explain the invention further.

### EXAMPLE 1 (COMPARISON)

This example illustrates the expansion behavior of conventional, native, expandable vermiculite from China.

Commercial, native vermiculite (20 mg) is weighed into a 150 μL corundum crucible and covered with a 150 μL steel crucible as lid, in order to achieve a uniform distribution of the load. Moreover, the steel crucible must dip far enough into the corundum crucible, in order to guarantee adequately good stability of the whole arrangement. Subsequently, this sample arrangement is placed in such a manner on the TMA sample stage, that the TMA measurement probe (quartz glass stirrup) contacts the bottom of the steel cable centrally. In this way, it is guaranteed than any change in length of the sample is recorded without interference by the TMA measurement probe. The sample is weighed down by a constant load of 0.06 N and heated at a rate of 20° C./min to 1100° C. The change in length is measured as a function of the temperature.

The material shows a first onset temperature of 320° C., and expansion volume of 14.8 (%/mg) and an expansion rate of 4.2 (%/° C.).

### EXAMPLE 2

Intercalation of sodium acetate by cation exchange in native, expandable vermiculite.

Native vermiculite (3 g, 0.05 moles) is placed in a 100 mL beaker and treated with stirring with an aqueous solution of 0.1 moles/L=5.0 moles/L of sodium acetate in solution in 30 mL of water. This reaction mixture is allowed to stand for three days at room temperature. It is then worked up by filtering the suspension through a glass filter with a pore size of G1 and washed with 100 mL of water in portions. Subsequently, the cation-exchanged vermiculite is dried for 12 hours at 60° C. in a drying oven. The material is stable for months.

The determination of the expansion behavior in the manner described above shows that the vermiculite-intercalation compound, obtained in this way, has an onset temperature of 277° C., a standardized expansion volume of 16.3 (%/mg) and an expansion rate of 16.4 (%/° C.).

### EXAMPLE 3

The intercalate compounds, given in the following Table 1, were intercalated in the expandable vermiculite by cation exchange in the Way described in Example of 2. The expansion properties of the vermiculite-intercalation compounds obtained are also summarized in the following Table.

TABLE

| | | | Ex- | |
|---|---|---|---|---|
| | | | pansion | |
| | | Onset | Stan- | |
| | | Tem- | dard- | |
| | | per- | ized | Expansion |
| | | ature | Volume | Rate |
| Host Type | Intercalate | [° C.] | [%/mg] | [%/° C.] |
| Native Vermiculite | —(Comparison) | 320 | 14.8 | 4.2 |
| Native Vermiculite | Dipotassium EDTA | 235 | 20.8 | 17.2 |
| Native Vermiculite | Potassium gluconate | 242 | 21.4 | 14.5 |
| Native Vermiculite | Potassium oxalate | 244 | 19.0 | 21.8 |
| Native Vermiculite | Potassium acetate | 248 | 20.8 | 18.6 |
| Native Vermiculite | Potassium formate | 252 | 19.2 | 17.9 |
| Native Vermiculite | Sodium acetate | 277 | 16.3 | 16.4 |
| Native Vermiculite | Sodium gluconate | 297 | 18.0 | 17.4 |
| Native Vermiculite | Lithium citrate | 347 | 20.4 | 16.2 |
| Native Vermiculite | Lithium acetate | 349 | 18.8 | 7.9 |
| Native Vermiculite | Sodium propylate | 356 | 17.4 | 23.7 |
| Native Vermiculite | Lithium formate | 358 | 19.0 | 21.6 |
| Native Vermiculite | KNO3 (Comparison) | 237 | 21 | 14.3 |

### EXAMPLE 4 (COMPARISON EXAMPLE)

For comparison purposes, potassium nitrate was intercalated by cation exchange in the same, native, expandable vermiculite in accordance with the teachings of U.S. Pat. No. 5,116,537 or of the corresponding European patent application 0 429 246. The vermiculite-intercalation compounds obtained have, as is also listed in the above Table 1, an onset temperature off 237° C., an expansion volume of 21 (%/mg) and an expansion rate of 14.3 (%/° C.).

However, it can be seen that it is possible, pursuant to the invention, to produce with the defined intercalation compounds the phyllosilicate-intercalation compounds, which are outstandingly suitable for fire-retardation and the expansion behavior of which can be adjusted selectively in any manner with regard to the onset temperature, the expansion volume and the expansion rate.

What is claimed is:

1. Method for producing phyllosilicate-intercalation compounds with at least one of an increased expansion rate and a modified onset temperature by intercalating an intercalate compound in native, expandable phyllosilicate, especially native vermiculite, wherein at least one representative of the group comprising alcoholates of lithium and potassium and salts of lithium, sodium and potassium with organic acids is intercalated by cationic exchange in the native phyllosilicate.

2. The method of claim 1, wherein a salt of an optionally substituted, organic carboxylic acid with one or more carboxyl groups is intercalated as intercalate compound.

3. The method of claim 2, wherein an optionally substituted organic carboxylic acid of the general formula R(COOH)ₙ, in which R represents an optionally substituted alkyl, cycloalkyl, alkenyl, cycloalkenyl, aryl, arylalkyl, arylcycloalkyl, alkylaryl, cycloalkylaryl group with 1 to 30 and preferably with 1 to 18 carbon atoms and n is a whole number with a value of 1 to 4 and preferably of 1 or 2.

4. The method of claims 2, wherein the organic carboxylic acid has, as substituents, one or more representatives of the group comprising halogen atoms, ether, ester, amino, amide, hydroxy and urea groups.

5. The method of claim 1, wherein a salt of formic acid, acetic acid, propionic acid, butyric acid, oxalic acid, tartaric acid, hexanoic acid, adipic acid, malonic acid, glycolic acid, citric acid, lactic acid, glyoxylic acid, trifluoroacetic acid salicylic acid, nitrilotriacetic acid and/or ethylenediaminetetraacetic acid (EDTA) is incorporated as intercalate compound.

6. The method of claim 1, wherein an alcoholates of lithium or potassium with a monovalent or multivalent, aliphatic or aromatic alcohol is intercalated as intercalate compound.

7. The method of claim 6, wherein an alcoholate of lithium or potassium with methanol, ethanol, 2-propanol, 2-butanol, t-butanol, benzyl alcohol, 1-decanol, ethylene glycol, 1,3-dihydroxypropane, 1-4-dihydroxybutane and/or glycerin is intercalated as intercalate compound.

8. The method of claim 1, wherein lithium citrate, lithium formate, lithium acetate, sodium acetate, sodium formate, sodium oxalate, sodium gluconate, sodium methylate, sodium ethylate, sodium propylate, potassium acetate, potassium gluconate, potassium oxalate and/or the dipotassium salt of ethylenediaminetetraacetic acid is intercalated as intercalate compound.

9. The method of claim 1, wherein expandable vermiculite, hydrobiotite and/or chlorite vermiculite with an average particle diameter of 0.1 mm to 10 mm and preferably of 0.3 to 1.0 mm is used as native, expandable phyllosilicate.

10. The method of claim 1, wherein the phyllosilicate is suspended in a solution of the intercalate compound in a suitable solvent, the intercalation optionally is carried out with heating and the phyllosilicate-intercalation compound obtained is removed from the suspension and optionally washed and dried.

11. The method of claim 10, wherein water, an aliphatic or aromatic alcohol, an ether, an ester, an alkane, a cycloalkane, an aromatic solvent and/or an amine is used as solvent.

12. The method of claims 10, wherein the intercalate compound preferably is used in a concentration of 0.1 moles/L to 5.0 mi./L and preferably of 0.1 moles/L to 1.0 moles/L.

13. The method of claim 10, wherein the intercalation reaction is carried out and a temperature of 10° C. to 150° C. and preferably of 25° C. to 60° C.

14. The method of claim 10, wherein the intercalation reaction is carried out for a reaction time of 0.5 to 144 hours and preferably of 10 to 36 hours.

15. The method of at least one of the claim 10, wherein the phyllosilicate-intercalation compound is removed from the suspension by filtering or decanting, optionally washed with a few milliliters of the solvent used and then dried.

16. The method of claim 15, wherein the drying is carried out at room temperature, under vacuum or in a drying oven at an elevated temperature.

17. The method off claim 16, wherein the drying is carried out in a drying oven for 1 to 12 hours at 60° to 80° C.

18. Phyllosilicate-intercalation compound, produced by intercalating an intercalate compound in native, expandable phyllosilicate, especially native vermiculite, wherein at least one representative of the group comprising alcoholates of lithium and potassium and salts of lithium, sodium and potassium with organic acids is intercalated by cationic exchange in the native phyllosilicate.

19. An intumescing material for use as intumescing, fire-retarding additive and/or in expanded form, can be used as additive for producing flame-retarding materials, as well as for preparing high temperature-resistant insulating panels and seals, especially for the for the fire-retarding sealing of through holes, wall bushings and other openings in at least one of walls, floors and/or ceilings of buildings, the intumescing material comprising a phyllosilicate intercalcation compound produced by intercalating an intercalate compound in native, expandable phyllosilicate, especially native vermiculite, wherein at least one representative of the group comprising alcoholates of lithium and potassium and salts of lithium, sodium and potassium with organic acids is intercalated by cationic exchange in the native phyllosilicate.
